(19) United States
(12) Patent Application Publication
(10) Pub. No.: US 2025/0280973 A1
(43) Pub. Date: Sep. 11, 2025

(54) DISPLAY ITEM MAGNETS MOUNTED ON BOARDS HAVING MAGNETIC RECEPTORS

(71) Applicant: Master Marketing Int’l Inc., dba Truly Engaging, Carol Stream, IL (US)

(72) Inventors: David Baird, Shoreview, MN (US); Mark Syswerda, Wheaton, IL (US)

(73) Assignee: Master Marketing Int’l Inc., dba Truly Engaging, Carol Stream, IL (US)

(21) Appl. No.: 18/599,396

(22) Filed: Mar. 8, 2024

(51) Int. Cl. A47G 1/06; G09F 7/18; H01F 7/02

(52) U.S. Cl. CPC A47G 1/0638; G09F 7/18; H01F 7/02; A47G 2001/0672; G09F 2007/1852

(57) ABSTRACT

An article and process for displaying items carrying or constituting magnets, such as photographs, which are magnetically mounted on sheets or other materials that contain magnetically-receptive materials. A retrofit process for transforming conventional display items into replenishable/switchable magnetic display items, also forms part of the present invention.

### BACKGROUND OF THE INVENTION

The present invention generally relates to articles and processes involving the use of display items magnetically mounted on boards having magnetic receptors.

It has long been known to mount photos on the wall using a mounting board (often referred to as “photo tiles”). For example, “Gilman” mounting boards are extruded polystyrene foamboards with acid-free paper facers offering two mounting surfaces free from damaging pollutants and harmful gasses. They are warp resistant so they will retain their thickness during mounting. This is an advantageous mounting solution for photographers, artists and the general public who desire a backing that will help preserve artwork for long-term display and storage. Alternatives to Gilman mounting boards, such as similar, soft, closed cell foam boards, are also available for this same purpose.

Recently, a company (Switch It Magnetic Frames, LLC of Cedar Rapids, Utah) has advertised a “patent pending” magnetic mounting product in which a frame adhesively mounted to a wall includes one or more magnets, capable of mounting display items, such as photographic images, which include magnetic receptors. A downside to this product is its cost. For example, with this system magnets are mounted inside the mounting boards or “frames,” which is not inexpensive. Additionally, printer costs for providing photographs with magnetic receptors, especially if separately-sourced from the mounting boards with magnets, may not be inexpensive.

To the inventors' knowledge, no one has attempted to magnetically mount a laminated display item, such as a laminated photograph, that itself constitutes a magnet to a mounting board having metal material constituting “magnetic receptors” attractive to the “display magnet,” for the purpose of displaying photos, other artwork, or other items to be displayed.

Additionally, sheets with metal powder, lined with adhesive, have also been used for various purposes but not, to the inventors' knowledge, for use in retrofitting mounting boards so they may be used to mount “display magnets” as discussed above.

Accordingly, there is a need for re-engineering conventional mounting boards with metal material to make them magnetically attracted to items to laminated “display magnets.”

### SUMMARY OF THE INVENTION

The objects mentioned above, as well as other objects, are solved by the present invention, which overcomes disadvantages of prior mounting boards and photos or other artwork to be displayed on them, while providing new advantages not previously associated with mounting boards and photos/artwork.

This summary is provided to introduce a selection of concepts in a simplified form that are further described below in the Detailed Description, so that the claimed invention may be better understood. However, this summary is not intended to limit the scope of the claimed subject matter.

In a preferred embodiment of the invention, an article to be displayed on a mounting board. The article includes or has attached to it a magnet which may be in sheet form, and the mounting board includes or has attached to it a magnetically-receptive material, which may also be in sheet form. The magnetically receptive material on the mounting board is magnetically attracted to the magnet associated with the article, allowing the article to be removably displayed on the mounting board.

The displayed article may be a photograph or other work of art. The mounting board may be removably attached to a wall or other fixed item useable for display, such as by using removable adhesive (liquid or not), gum or Velcro®.

The magnetically-receptive material associated with the mounting board may be applied to a separate sheet that is permanently or removably attached to the mounting board, such as by adhesive, gum or Velcro®. The sheet with the magnetically-receptive material may be initially covered with a pressure-sensitive peelable liner, to protect the adhesive when not in use.

As one preferred example, the magnet associated with the article may be provided with a magnetic strength of no less than 16 poles/inch (ppi).

A process for displaying an article on a mounting board also forms a preferred embodiment of the present invention. In this process, an article to be displayed may be formed into a magnet. Next, a mounting board may be provided with, or fabricated with, a magnetically-receptive material that is magnetically attracted to the display article magnet. In this process, the display article may be a photograph or other work of art. The display article may be formed into a magnet by attached a separate sheet that it itself a magnet. The separate sheet may be formed as a magnet by attaching iron steel filings or other material to the sheet. Next, the sheet may be permanently or removably attached to the display article. This process may also include one or more of the following steps: laminating the display article; embellishing the display article, such as with foil or varnish; and framing the display article prior to mounting the display article on a wall or other area for display

A process for retrofitting an original mounted display article that does not include magnets or magnetically-receptive material, so that a new display article is provided, also forms a part of the present invention. In this retrofit process, an attachment sheet is provided that includes a first face with magnetically-receptive material and an opposing second face with adhesive material. A new display article is also provided, which includes one or more magnets. The second face of the attachment sheet with the adhesive material is attached over the top of the mounted display article.

Now, the new display article is attached over the first face of the attachment sheet. The magnetically-receptive material on the first face of the attachment sheet is now magnetically attracted to the one or more magnets of the new display article. Preferably, in this retrofit process, the adhesive on the second face of the attachment sheet is aggressively repositionable. “Aggressively repositionable” means that the adhesive causes the attachment sheet to remain attached to the original mounted display article during normal use (i.e., as new display article magnets are attached and removed), but the adhesive permits the attachment sheet to be manually removed from one new display article, and re-attached to another new display article, without leaving any appreciable adhesive residue remaining on the removed display article.

With the retrofit process, the original mounted display article may include a laminated sheet with a photograph on a first face, and an opposing second face that is permanently attached to a mounting material. The mounting material may be one or more of the following (as non-exhaustive examples): glass; acrylic; plastic; foamboard.

### Definition of Claim Terms

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

“Display item magnet” means a photograph, piece of artwork or other item to be displayed, that constitutes a magnet.

“Magnetic receptor” means any material containing metal that can be attached to, carried by, or imbued within a mounting board, and that is magnetically attracted to the display item magnet, permitting the display item magnet to be mounted on the mounting board.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a planar perspective view of a laminated photograph with magnetic material according to the present invention;

FIG. 2A is a planar perspective view of an adhesive-backed sheet with a peelable liner, in which the sheet carries metal material which is attracted to the photograph (or other display item) with magnetic material of FIG. 1;

FIG. 2B is a planar perspective view showing a portion of the sheet of FIG. 2A peeled back so that an adhesive portion of the sheet is exposed; and

FIG. 3 is a side and front perspective view showing the different components (display item magnet 10, magnetic receptor sheet 20, and mounting board 30) in one preferred embodiment of the present invention; and

FIG. 4 is a side and top perspective view showing the laminated photograph of FIG. 1, with liner 27 of magnetic receptor sheet 20 removed, so that adhesive material 25 can be applied to front face 31 of mounting board 30, such that it will be magnetically attracted to laminated display item magnet 10.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

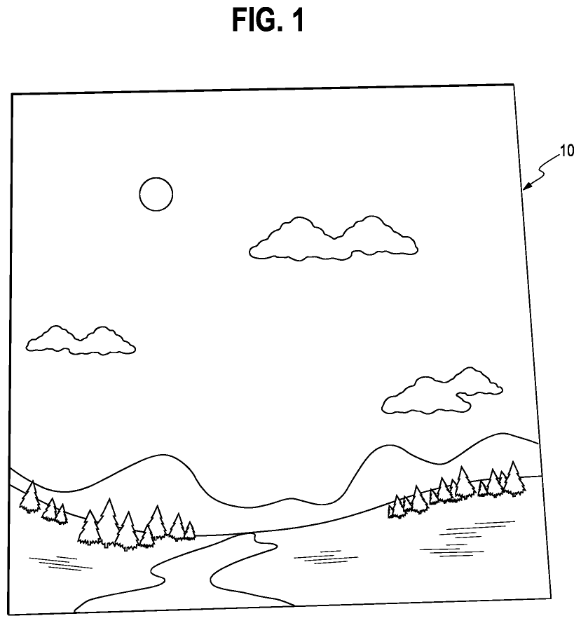

In a first preferred embodiment, and referring first to FIG. 1, a display item constituting a magnet, such as laminated photograph magnet 10, is shown. Photograph magnet 10 can be fabricated in various ways, as discussed below.

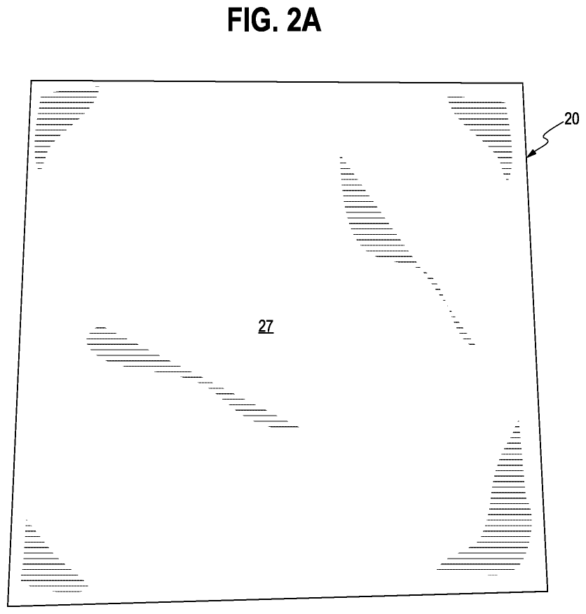

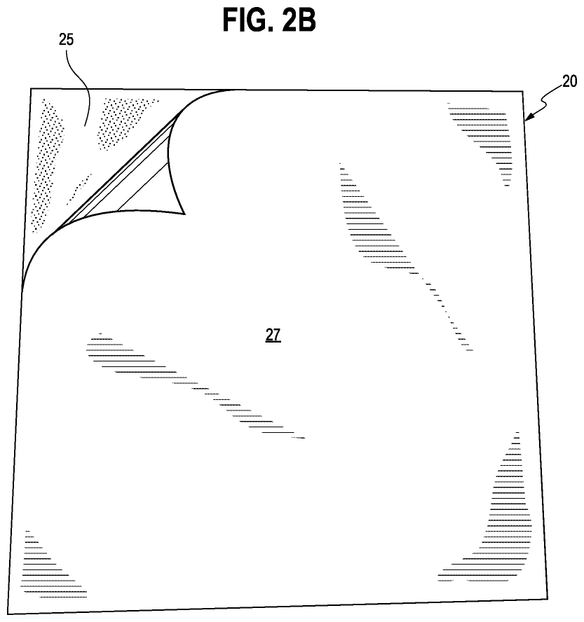

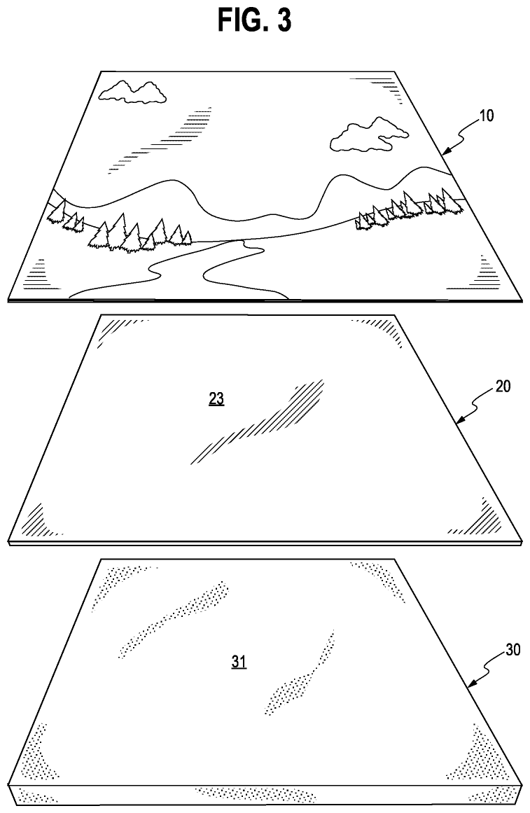

Referring to FIG. 2A, and still referring to this first preferred embodiment, a magnetically receptive sheet 20 containing at least some metal material is shown. As seen in FIG. 2B, the rear of sheet 20, face 25, may be coated with adhesive 26, and may be covered by a protective, pressure-sensitive peelable liner 27. The opposite side of sheet 20 (face 23 shown in FIG. 3) carries at least some metal material that functions as a magnetic receptor (i.e., which is attracted to photo magnet 10). Referring to FIG. 3, face 25 carrying adhesive 26, with liner 27 peeled away and removed, can now be adhesively applied to the front face of mounting board 30. Mounting board 30, carrying the magnetically-receptive material on attached sheet 20, will now attract and mount “photo magnet” 10.

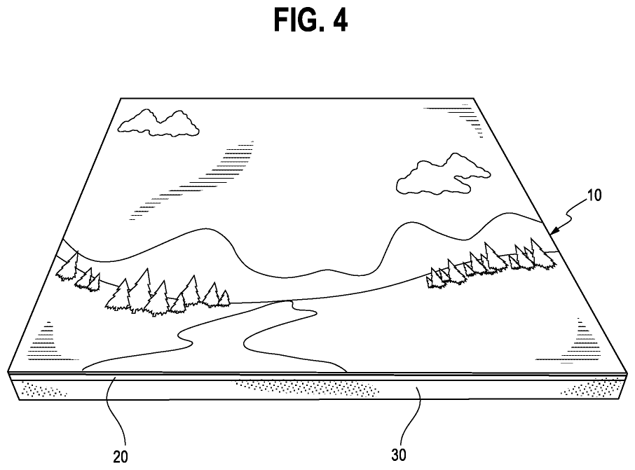

According to the present invention, and referring to FIGS. 1-4, conventional mounting boards can be converted to magnetic receptors by attaching sheets carrying at least some metal material. The rear surface of the mounting board can be permanently or removably adhesively attached, using glue, gum or other suitable adhesive (e.g., 3M® tape), or attached using Velcro® (not shown), to a wall or other mounting surface. Then, in one preferred example, a peelable adhesive liner 27 may be used; back face 25 of sheet 20 (the side covered by liner 27) may be an adhesive surface which can adhere to front face 31 of mounting board 30. Face 23 of sheet 20 (the opposite side to adhesive face 25) includes metal material constituting magnetic receptors, which attract to display item magnet 10 (fabricated as discussed below).

When used to retrofit a conventional mounting board, face 25 with adhesive 26 is preferably an “aggressively repositionable” adhesive that securely attaches sheet 20 to mounting board 30, while also allowing sheet 20 to be removed from mounting board 30 should there be a need to do so (e.g., a user wants to replace sheet 20 with a different sheet), as discussed immediately below.

Conventional mounted displays, such as using mounted photographs, may consist of a label/paper printed photo (the photos of the present invention may be printed using digital ink printing, laser printing or any other print format) that is permanently attached to a material such as glass, acrylic, plastic, foamboard, or another display substrate. (For purposes of this paragraph, a “conventional mounted display” does not include magnets or magnetically-receptive materials.) The present invention also provides a retrofit solution for using such conventional mounted displays, as is now described.

In one preferred retrofit solution according to the present invention, an adhesive 26, which is preferably an “aggressively repositionable” adhesive, is used. Adhesive 26 is provided on one side of magnetically-receptive sheet 20 (with the opposing side of sheet 20 carrying the magnetically-receptive material), and the adhesive side of sheet 20 is attached over the top of the existing photo (or other article to be displayed) of the conventional mounted display. Now, a new display magnet 10, such as a photo magnet 10, can be laid over the side of sheet 20 carrying the magnetically-receptive material, ensuring magnetic attraction between the two contiguous faces.

Regarding adhesive 26, “aggressively repositionable” here means that the magnetically-receptive sheet 20 remains attached to the conventional mounted display during normal use (“normal use” here refers to the process of new display article magnets 10 being attached and removed, in the customer's discretion), but that magnetically-receptive sheet 20 is capable of being manually removed from the conventional mounted display, without leaving any appreciable adhesive residue remaining on the conventional mounted display. Accordingly, this allows the client's previously-mounted, conventional mounted display to be retrofitted with a different display, at the customer's discretion, providing a dynamic, reusable, refreshing, renewing “photo tile” solution using a different magnetically-receptive sheet 20.

An example of an adhesive 26 that can be used is the adhesive used on a 3M® Post-It® note, which will allow the retrofitted, magnetically-receptive material to be applied and removed from a conventional mounted display with ease. However, a downside of using a Post-It® note-type-adhesive is the fact that the staying power of this type of adhesive diminishes over time. Another potential example is the use of Velcro® as the adhesive. A more optimum solution would be to utilize a liquid adhesive, applied via a PSA (pressure-sensitive adhesive) liner, that provides the “aggressively repositionable” properties mentioned above.

One example of a sheet 20 with magnetic receptors is known as FerroSheet™ Magnetic Receptive Media available from Arnold Technologies—Flexmag Industries, Inc. of Marietta, Ohio. FerroSheet™ has iron steel filings along with rubber powder distributed on one side of the sheet, and an adhesive covered by a peelable liner on the other side of the sheet. The sheets are available in rolls, and can be die-cut to size. An average thickness of these sheets, for example, is 0.015-0.030 inches.

Another way to re-engineer a conventional mounting board into a magnetic mounting board for use with the present invention is to spray or paint a liquid-based or gas-based metal material to the mounting board, in a permanent fashion. An exemplary liquid-based magnetic material which can be painted on the mounting board is available from, e.g., Home Depot, and is known as MQ2-61 Magnet One-Coat Hide Satin Enamel Interior Paint & Primer. Another is “Magnetize-It! Magnetic Paint & Primer,” MISTD-1530, available on Amazon.

Yet another way to engineer a conventional mounting board into a magnetic mounting board for use with the present invention is to imbue the mounting board, during the manufacturing process, with a sufficient quantity of a mixture of rubber along with ferro (or iron/ground steel filings). This will attract an actual magnet, such as one made up of rubber and strontium ferrite powder with the correct polarity. Again, this is intended to provide a permanent solution of a mounting board with magnetic receptors.

Preferred ways to fabricate display item magnet 10, referred to in the first preferred example as “photo magnet” 10, are now described. In one preferred example, a display item such as a photograph 10 may be fabricated with the following layers: a printed face, including a face stock with a photograph, if desired a protecting/enhancing laminate applied to the printed face, and an adhesive-backed magnetic material applied to the printed face.

As one specific example, photographs can be submitted to Truly Engaging™ of Carol Stream, which will then print them (a “face stock”) on a variety of substrates (e.g., 100% recyclable board stock, such as 16-point paper, coated on one side), using (e.g.) a HP Indigo 12000 Digital Press printer.

Next, the photographs on face stock can be laminated with a protecting/enhancing laminate such as a glossy lamination (e.g., 1-mil polypropyelene) using (e.g.) an Autobond laminator, or a matte (soft-touch) lamination (e.g., 1-2 mil, smudge-proof (velvety feel)) using (e.g.) a Saggita laminator.

Now, foil or embellishment can be applied to the photo/laminated side of the face stock using (e.g.) a Scodix printer, such as a Scodix Machine Ultra 1000 or Ultra 2000 printer.

Next, the magnet can be applied, such as by using a die-cutting machine (e.g., a Preco or Interflex Magnetic die-cutter) to the back/unprinted side of the face stock. One preferred magnet is available from Flexmag, known as “Magnetic Material With Indoor Adhesive” (standard energy, calendared material), magnetized at 16 poles per inch (ppi). This comes in adhesive-backed sheets, and the adhesive can be applied to the back side of the printed face stock.

Additionally, frames, such as snap-on plastic frames, wood frames, or other frames, can be applied to the display item magnet, prior to magnetically mounting the display item to the mounting board with the magnetic receptors. It may be desirable to adjust the magnetic attraction strength for certain display applications. For example, if a heavier wooden frame is to be used, then a stronger magnetic attraction strength may be desirable. Adjusting the magnetic attraction strength can be done, for example, by varying the distance between the magnetized materials, or by changing the magnetic strength directly of the material (its poles/inch).

In one preferred example, a display item magnet, such as a laminated photograph on paper stock as described above, is no less than 12 mil thick (0.012″), with no less than 16 poles/inch of magnetization (16 ppi). The magnetized attraction can be increased (due to the presence of a heavier display item, for example), by decreasing the ppi (creating bigger gaps between poles, and stronger “grip” magnetization).

It will now be understood that use of the present invention allows for various advantages. For example, display items such as printed photo magnets can be easily and quickly swapped out from magnetic receptive mounting boards in mere seconds; there is thus no premium on getting the arrangement right the first time or deciding which prints make the final cut, as swapping display items is easy and cost-efficient. Using the present invention also provides for a myriad of design and décor possibilities, using different combinations of mounting board, display items and frames, making use of the present invention ideal for home décor and design enthusiasts. Additionally, by using the present invention, users need only pay for replacement prints when changing a gallery wall, and not for a full complete mounting base and printed photograph, as with other systems. Users can thus prepare a gallery wall without spending the time or money it typically takes to search, design and install such a wall.

It will now also be understood that the present invention permits the creation of a gallery wall system featuring premium display item magnets, mountable on boards containing magnetic receptors, such that the display items can be switched in mere seconds. The display item magnets can also be customized with foil and gloss/varnish embellishments.

The above description is not intended to limit the meaning of the words used in the following claims that define the invention. Persons of ordinary skill in the art will understand that a variety of other designs still falling within the scope of the following claims may be envisioned and used. It is contemplated that these additional examples, as well as future modifications in structure, function, or result to that disclosed here, will exist that are not substantial changes to what is claimed here, and that all such insubstantial changes in what is claimed are intended to be covered by the claims.

We claim:

1. An article to be displayed on a mounting board attached to a wall or other fixed item useable for display, wherein the article constitutes a magnet, and wherein the mounting board includes a magnetically-receptive material that is attracted to the article magnet, thereby allowing the article to be displayed on the mounting board.

2. The article of claim 1, wherein the article comprises a photograph or other work of art.

3. The article of claim 1, wherein the mounting board is removably attached to the wall or the other fixed item useable for display, using adhesive, gum or Velcro®.

4. The article of claim 1, wherein the magnetically-receptive material is located on a sheet having a first face, and wherein the sheet has a second opposing face with an adhesive allowing the sheet to be permanently or removably attached to the mounting board.

5. The article of claim 4, wherein the adhesive is covered with a peelable liner prior to the sheet being attached to the mounting board.

6. The article of claim 1, wherein the magnet of the displayed article has a magnetic strength of no less than 16 ppi.

7. An article to be displayed on a mounting board, wherein the article carries, or is otherwise associated with, one or more magnets, and wherein the mounting board includes magnetically-receptive material carried by or otherwise associated with the mounting board, whereby the article is mounted to the mounting board by magnetic attraction.

8. The article of claim 7, wherein the magnetically-receptive material is applied to an attachment sheet attached to the mounting board.

9. The article of claim 7, wherein the magnetically-receptive material is directly applied to the mounting board.

10. A process for displaying an article on a mounting board, comprising the steps of:
providing the article with a magnet; and
providing the mounting board with a magnetically-receptive material that is attracted to the article magnet;
whereby the article may be displayed on the mounting board.

11. The process of claim 10, wherein the article comprises a photograph printed on paper, and wherein the photograph is attached to a sheet carrying the magnet.

12. The process of claim 11, wherein the sheet includes an adhesive face.

13. The process of claim 10, wherein the magnetically-receptive material is adhered to an attachment sheet which is adhesively attached to the mounting board.

14. The process of claim 10, further providing: a first sheet which includes a first face with magnetically-receptive material, and an opposing second face with adhesive material covered by a peelable liner; and a second sheet which includes a first face comprising a photograph and an opposing second face comprising a magnet.

15. The process of claim 14, further comprising the steps of:
peeling the liner off of the second face of the first sheet to expose the adhesive material;
attaching the second face of the first sheet with the adhesive material to a face of the mounting board; and
mounting the article magnet to the first face of the first sheet that is now mounted on the face of the mounting board;
whereby the article remains attached to the mounting board by reason of the magnetic attraction between the magnet of the article, and the magnetically-receptive material on the second face of the first sheet attached to the mounting board.

16. The process of claim 15, further comprising the step of laminating the photograph on the first face of the second sheet.

17. The process of claim 15, further comprising the step of embellishing the photograph on the first face of the second sheet.

18. The process of claim 17, further comprising the step of providing foil or varnish on the photograph on the first face of the second sheet.

19. The process of claim 15, further comprising the step of framing the article prior to the mounting step.

20. A process for retrofitting an original mounted display article that does not include magnets or magnetically-receptive material, so that a first new display article is provided, comprising the steps of:
providing an attachment sheet that includes a first face with magnetically-receptive material and an opposing second face with adhesive material;
providing a first new display article, wherein one or more magnets are associated with the first new display article;
attaching the second face of the attachment sheet with the adhesive material over a top of the original mounted display article; and
attaching the first new display article over the first face of the sheet, thereby allowing the magnetically-receptive material on the first face of the sheet to be magnetically attracted to the one or more magnets of the first new display article;
whereby the original mounted display article is replaced by the first new display article which is now mounted.

21. The retrofit process of claim 20, further comprising the step of removing the first new display article and replaced the first new display article with a second new display article associated with one or more magnets.

22. The retrofit process of claim 20, wherein the adhesive material on the second face of the attachment sheet is aggressively repositionable.

23. The retrofit process of claim 20, wherein the original mounted display article comprises a laminated sheet with a photograph on a first face, and an opposing second face that is permanently attached to a mounting material.

24. The retrofit process of claim 23, wherein the mounting material comprises one or more of the following: glass; acrylic; plastic; foamboard.
